(19) United States
(12) Patent Application Publication
(10) Pub. No.: US 2017/0225992 A1
(43) Pub. Date: Aug. 10, 2017

(54) Concentrated Wastewater Slurry Thickening and Storage System and Stabilization Batch Treatment Plant

(71) Applicant: HEARTLAND TECHNOLOGY PARTNERS LLC, St Louis, MO (US)

(72) Inventors: Bernard F. Duesel, JR., Goshen, NY (US); Michael J. Rutsch, Pittsburgh, PA (US); Craig Clerkin, Stoughton, WI (US)

(21) Appl. No.: 15/493,969

(22) Filed: Apr. 21, 2017

Related U.S. Application Data
(62) Division of application No. 13/793,546, filed on Mar. 11, 2013.

(51) Int. Cl. C02F 11/14; B01D 1/30; B01D 1/14; C02F 1/04; C02F 11/12

(52) U.S. Cl. CPC C02F 11/14; C02F 1/048; C02F 11/12; B01D 1/14; B01D 1/305; C02F 2103/10

(57) ABSTRACT

A wastewater concentrator a liquid evaporator assembly, a gas-liquid separator, an exhaust assembly, and a slurry thickening and storage system. The slurry thickening and storage system includes a slurry thickening tank fluidly connected to the gas-liquid separator and a thickened slurry storage tank fluidly connected to the slurry thickening tank.

### BACKGROUND

Field of the Disclosure

The present disclosure generally relates to systems and apparatuses for concentrating wastewater by separating and removing a water constituent from the wastewater and more specifically to wastewater concentrators having a concentrated slurry thickening and storage system and/or a stabilization batch treatment plant.

Background

Wastewater of any form is often initially generated in a very dilute form, having a very low concentration of waste material, such as suspended solids, salts, and other contaminants, mixed with water. Treatment of wastewater generally involves various processes aimed at separating the water portion from the waste material so that the water can be returned to the environment substantially free of the waste material. The waste material may then be processed further, deposited in a landfill, or otherwise disposed of.

Often, the source of wastewater is located a substantial distance from a wastewater treatment facility and must be transported to the wastewater treatment facility by, for example, pipelines or trucks. The costs of transporting the wastewater can be a significant portion of the total cost of treating the wastewater, and significant savings can be realized by reducing the transportation costs. One way to reduce the transportation costs for wastewater is to minimize the volume of the wastewater that must be transported. This can be accomplished by removing water from the dilute wastewater in the field, i.e., near the source and before being transported, so that less volume needs to be transported.

Wastewater concentrators are used to remove water from the wastewater by, for example, evaporating clean water from the wastewater. The products from a wastewater concentrator are clean water vapor, which can be exhausted to air, and a more concentrated form of the wastewater. In some ideal processes, the wastewater is concentrated to the point of becoming a slurry.

Even concentrated wastewater slurries can contain 40% or more liquid. This remaining liquid continues to take up space (and therefore cost money) in transportation vehicles. However, conventional wastewater slurry thickening/storage systems are based on process trains that are generally expensive to purchase and also quite complicated and expensive to operate and maintain.

### SUMMARY

In accordance with one exemplary aspect, a wastewater concentrator includes a liquid evaporator assembly, a gas-liquid separator, an exhaust assembly, and a slurry thickening and storage system. The slurry thickening and storage system includes a slurry thickening tank fluidly connected to the gas-liquid separator and a thickened slurry storage tank fluidly connected to the slurry thickening tank.

In accordance with another exemplary aspect, a slurry thickening and storage system for a wastewater concentrator includes a slurry thickening tank having a stirring rod and a rake operatively connected to the stirring rod and a thickened slurry storage tank having a mixing shaft and a plurality of stirring blades operatively connected to the mixing shaft.

In further accordance with any one or more of the foregoing aspects, a wastewater concentrator (or a slurry thickening and storage system) may further include any one or more of the following preferred forms.

In some preferred forms, the wastewater concentrator (or the slurry thickening and storage system) may include a stirring rod and a rake operatively attached to the stirring rod. In other preferred forms, the stirring rod rotates at between 1 RPM and 10 RPM. In yet other preferred forms, the stirring rod is operatively connected to a gearbox including a single reduction, single planetary gear assembly. In yet other preferred embodiments, the gearbox may be balance-weight driven. In yet other preferred embodiments, an electric motor may be operatively connected to the gearbox, the electric motor being a 2 HP motor that delivers approximately 70,400 in-lb of torque at approximately 2 RPM. In yet other preferred embodiments, an inner surface of the slurry thickening tank may include an inner epoxy liner that is approximately 30 mil thick. In yet other preferred embodiments, the thickened slurry storage tank may include a mixing shaft and a plurality of stirring blades operatively connected to the mixing shaft. In yet other preferred embodiments, at least one stirring blade in the plurality of stirring blades may comprise stainless steel. In yet other preferred embodiments, a breaker mechanism may be operatively attached to a bottom of the mixing shaft. In yet other preferred embodiments, a gearbox may be operatively connected to the mixing shaft, and the gearbox may comprise a parallel shaft, helical gear assembly. In yet other preferred embodiments, an electric motor may be operatively coupled to the gearbox the electric motor being a 15 HP motor that rotates the mixing shaft between 30 RPM and 60 RPM. In yet other preferred embodiments, a tank heater may be coupled to the thickened slurry storage tank, the tank heater being a thermostatically controlled 3 KW 120 V electric heater.

In accordance with another exemplary aspect, a wastewater concentrator includes a liquid evaporator assembly, a gas-liquid separator, an exhaust assembly, and a water recovery system. The water recovery system includes a secondary exhaust stack fluidly connected to the exhaust assembly, the secondary exhaust stack including a direct contact heat exchanger.

In further accordance with any one or more of the foregoing aspects, a water recovery system for a wastewater concentrator may further include any one or more of the following preferred forms.

In some preferred forms, a fan may be operatively connected to the secondary exhaust stack and to the exhaust assembly, the fan operating to draw a portion of gas in the exhaust assembly into the secondary exhaust stack. In other preferred forms the secondary exhaust stack may include a sump for collecting condensed water droplets, the sump being fluidly connected to a recovered water storage tank. In yet other preferred forms, the direct contact heat exchanger may be fluidly connected to a source of cooled liquid. In yet other preferred forms, the water recovery system may include a direct contact condenser column that has high efficiency packing. In yet other preferred embodiments, the direct contact condenser column may include an entrainment separator. In yet other preferred embodiments, the direct contact heat exchanger may be capable of recovering between 1% and 5% of the water vapor that is evaporated from a feed liquid concentrated by the wastewater concentrator.

In accordance with another exemplary aspect, a batch treatment and stabilization plant for treating and stabilizing slurry formed from concentrating a wastewater stream includes a central batch processing plant, the central batch processing plant having a slurry inlet, a slurry outlet, one or more additive inlets, and one or more stabilizer inlets.

In further accordance with any one or more of the foregoing aspects, a batch treatment and stabilization plant may further include any one or more of the following preferred forms.

In some preferred embodiments, an additive may comprise a sulfate and a stabilizer may comprise Portland cement. In yet other preferred embodiments, a plurality of slurry storage tanks may be operatively connected to the central batch processing plant, each slurry storage tank in the plurality of storage tanks being fluidly connected to a wastewater concentrator, at least one of the wastewater concentrators being operatively connected to a source of produced water from a natural gas well. In yet other preferred embodiments, a plurality of storage containers may be operatively connected to the central batch plant for storing slurry after being mixed with an additive or a stabilizer.

Other aspects and advantages of the present invention will become apparent upon consideration of the following detailed description.

### BRIEF DESCRIPTION OF THE DRAWINGS

FIG. 1 is an isometric view of a wastewater concentrator assembly;

FIG. 2 is a cross-sectional elevation of the wastewater concentrator assembly along the lines 2-2 of FIG. 1;

FIG. 2A is a schematic piping and instrumentation diagram generally along the cross-sectional elevation of FIG. 2;

FIG. 3 is a cross-sectional elevation of the wastewater concentrator assembly along the lines 3-3 of FIG. 1;

FIG. 4 is an isometric view of the wastewater concentrator assembly installed for use on a concrete pad and connected to a slurry thickening and storage system;

FIG. 5 is a side cross-sectional view of a thickening tank and a thickened slurry storage tank of the slurry thickening and storage system of FIG. 4;

FIG. 6 is a schematic view of a water recovery assembly that is fluidly connected to an exhaust stack of the concentrator of FIG. 1 for recovering a portion of evaporated water vapor; and

FIG. 7 is a schematic view of a plurality of wastewater concentrators all feeding a common stabilization batch plant.

### DETAILED DESCRIPTION

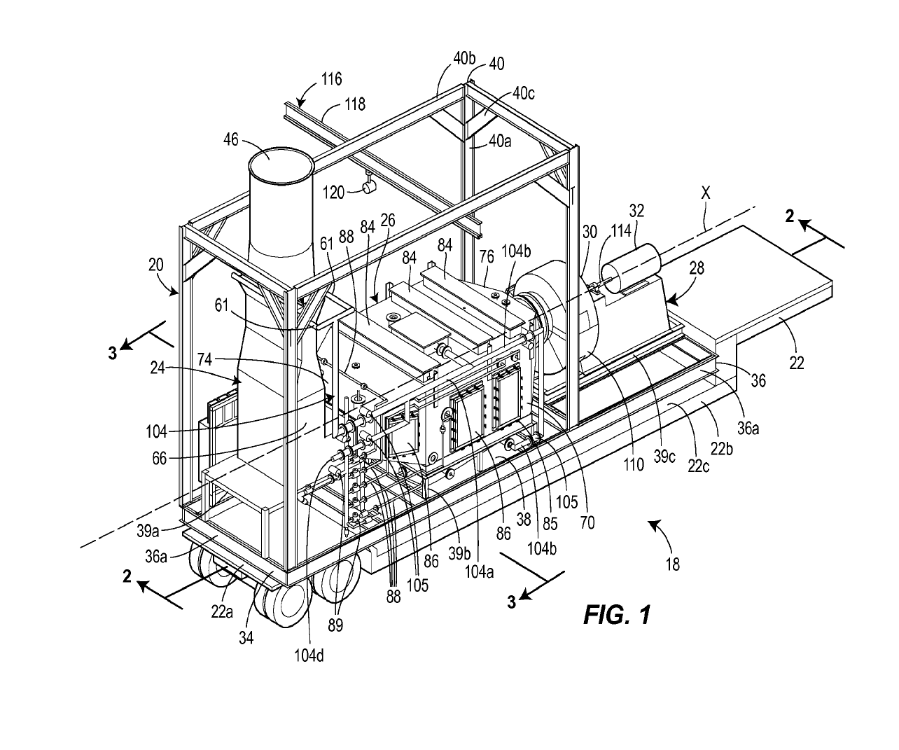

Turning now to the drawings, FIGS. 1-3 illustrate one embodiment of a wastewater concentrator assembly 18 including a wastewater concentrator 20 being carried on a mobile hauling platform 22, such as a truck bed or a trailer, as a single unit. The wastewater concentrator 20 can be hauled as a substantially single unit on the mobile hauling platform 22 on highways and service roads and may be set up for operation either on the hauling platform or may removed from the hauling platform 22 as a single unit and be installed in a permanent or semi-permanent arrangement at a remote operating site, such as an industrial plant, mine site, petrochemical or natural gas extraction site, and the like. In other embodiments, the wastewater concentrator 20 may be transported in multiple pieces, or even as individual components that may be assembled at the operating site. In addition, the wastewater concentrator 20 is sizable to have an effective treatment capacity of up to forty thousand gallons per day or more without requiring substantial modification to the basic design disclosed herein. The wastewater concentrator 20 in some arrangements includes many aspects and design details of the wastewater concentrators described in detail in U.S. patent application Ser. No. 12/705,462 filed, Feb. 12, 2010, which is incorporated by reference in its entirety herein.

The mobile hauling platform 22 is preferably a semi-trailer, such as a standard double-drop semi trailer, having an upper level carrying surface 22a and a lower level carrying surface 22b defining a recessed portion 22c below the upper level carrying surface. However, the mobile hauling platform 22 may be any hauling platform with wheels or tracks, for example, that is adapted to be drawn or moved by a truck, tractor, team of oxen, or other such mobile pulling unit capable of carrying the wastewater concentrator 20 on roads and over ground. Alternatively, for example, the mobile hauling platform 22 could be a flat bed truck. In some optional arrangements, the wastewater concentrator is carried by a first mobile hauling platform, such as a semi-truck trailer, and accessories are carried by one or more additional mobile hauling platforms, such as by two additional semi-truck trailers. In an optional arrangement, a permanent wastewater concentrator unit may be formed by integrating a skid 34 to a standard single drop trailer, wherein the skid and trailer frame are permanently secured together into a single unit, such as by welding or fasteners.

The wastewater concentrator 20 includes a liquid evaporator assembly 24, an entrainment separator or demister in the form of a gas-liquid separator 26, and an exhaust assembly 28. The gas-liquid separator 26 is operatively connected with the liquid evaporator assembly 24, and the exhaust assembly 28 is operatively connected with the gas-liquid separator 26. The wastewater concentrator 20 also includes an air pump 30, such as a fan, and a power source 32, such as an electric or pneumatic motor, arranged to drive the air pump 30. The skid 34 may carry and support the components of the wastewater concentrator 20 as a single unit in the embodiment illustrated in FIGS. 1-3. Together, the liquid evaporator assembly 24, the gas-liquid separator 26, and the exhaust assembly 28 form a confined gas flow path P, wherein gases and/or entrained wastewater flow along the confined gas flow path P through the wastewater concentrator 20 from the liquid evaporator assembly 24 through the gas-liquid separator 26 and out the exhaust assembly 28 to the surrounding atmosphere and/or other discharge ports.

The skid 34 may take any form sufficient to allow the wastewater concentrator 20 to be lifted as a single unit off of the mobile hauling platform 22 and onto an operating platform at an operating site by, for example, a crane. In a preferred arrangement, the skid 34 forms a generally planar horizontal support frame 36 formed of beams 36a, such as steel I-beams, C-section beams, tubing, and the like, in a rectangular shape sufficient to surround an outer peripheral footprint of the liquid evaporator assembly 24, the gas-liquid separator 26, and the exhaust assembly 28. The beams define at least a central opening 38, and preferably define several openings through the horizontal support frame 36. The horizontal support frame 36 preferably is disposed at least below the liquid evaporator assembly 24, the gas-liquid separator 26, the air pump 30, and the power source 32, each of which is preferably secured to the horizontal support frame 36, either directly or indirectly by intermediate supports, such as support frames 39a, 39b, and 39c. The horizontal support frame 36 in the depicted arrangement includes four peripheral I-beams, including of two long beams and first and second end cross-beams connected to form a rectangle having a long dimension aligned with a longitudinal axis of the liquid evaporator assembly 24, gas-liquid separator 26, and exhaust assembly 28; first, second, and third longitudinally spaced apart cross-beams extending orthogonal to the longitudinal axis between the first and second end cross-beams and disposed under the gas-liquid separator; and first and second laterally spaced apart longitudinal runners extending from the second end cross-beam to the adjacent third cross-beam under the exhaust assembly 28. The skid 34 is arranged to be removably supported by the mobile hauling platform 22, for example with the horizontal support frame 36 disposed on the upper level 22a of the mobile platform 22.

The support frames 39a, 39b, and 39c support and connect the liquid evaporator assembly 24, gas-liquid separator 26, and exhaust assembly 28, respectively, to the horizontal support frame. In the arrangement depicted in the drawings, the support frame 39a is in the form of a table having a top and four legs, wherein the liquid evaporator assembly 24 rests on the top, and the four legs are connected to the first end cross-beam and the adjacent first cross-beam of the support frame 36. The support frame 39b is in the form of a rectangular upper frame and four legs disposed over the central opening 38, wherein the upper frame is connected to an underside periphery of the gas-liquid separator 26, and the four legs are connected to the first cross-beam and second cross-beam of the support frame 36. The support frame 39b does not have a top and a sump of the gas-liquid separator projects downwardly through the rectangular upper frame and the central opening 38 as described hereinafter. The support frame 39c is in the form of a rectangular frame formed of I-beams, wherein the air pump 30 and power plant 32 are connected to the rectangular frame and the rectangular frame is connected to the first and second longitudinal runners, the second end cross-beam, and the adjacent third cross-beam.

The skid 34 preferably also includes a lift frame 40 extending above the horizontal frame formed, for example, of columns and cross-beams of steel members, such as I-sections, C-sections, tubing, and the like. The lift frame 40 in the depicted arrangement includes four vertical columns 40a extending upwardly from an outer periphery of the horizontal support frame 36; longitudinal beams and cross-beams 40b that form a rectangular frame and connect the vertical beams; and corner braces 40c at one or more of the intersections between a longitudinal beam 40b, a cross-beam 40b, and a vertical column 40a. The vertical columns 40a preferably are located around the outer periphery of a significant portion of at least the liquid evaporator assembly 24 and gas-liquid separator 26, as shown in the drawings, thereby forming a scaffolding surrounding at least the same. The lift frame 40 is in some arrangements used to support a hoist, as described hereinafter, and may be constructed after the skid 34 is set in place at an operating location.

The skid 34 may be made of any materials suitable for supporting the wastewater concentrator 20 as a movable unit as described herein, such as steel, and connected, for example, by welds, bolts, and/or rivets. Preferably, the skid 34 is sized and arranged to be hauled on a semi-truck trailer on highways. In one arrangement, as depicted in the drawings, the skid 34 has a length along the longitudinal axis of approximately thirty nine feet (11.89 m), a width of approximately ten feet four inches (3.15 m), and a height of approximately twenty feet (6.10 m).

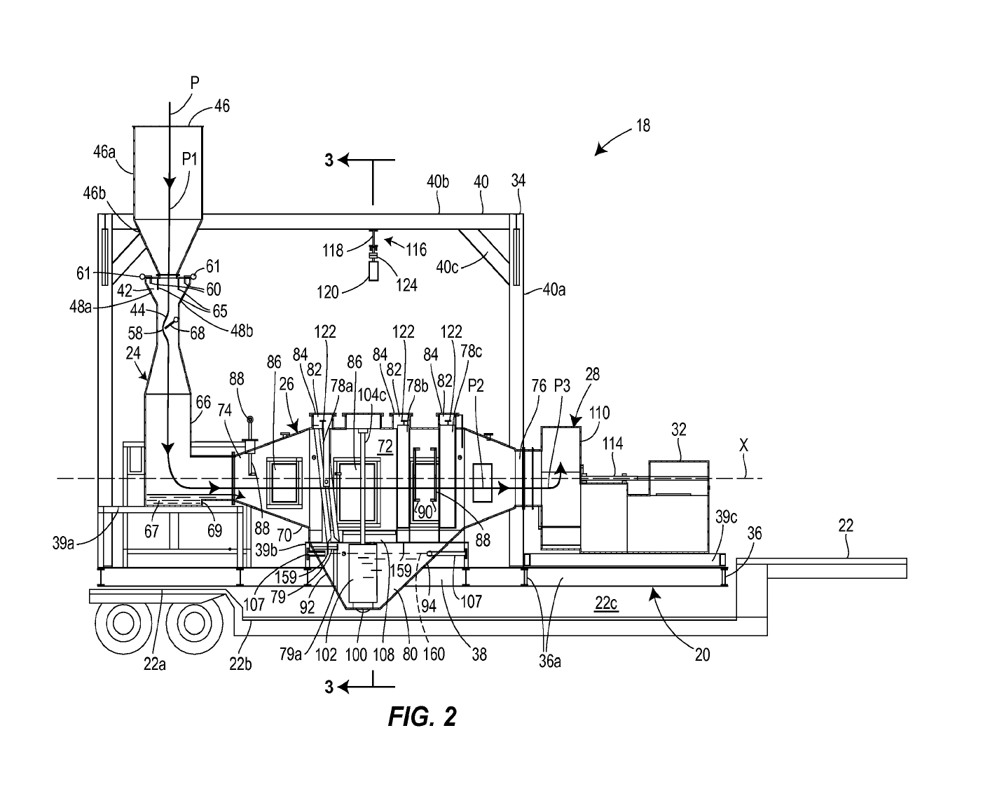

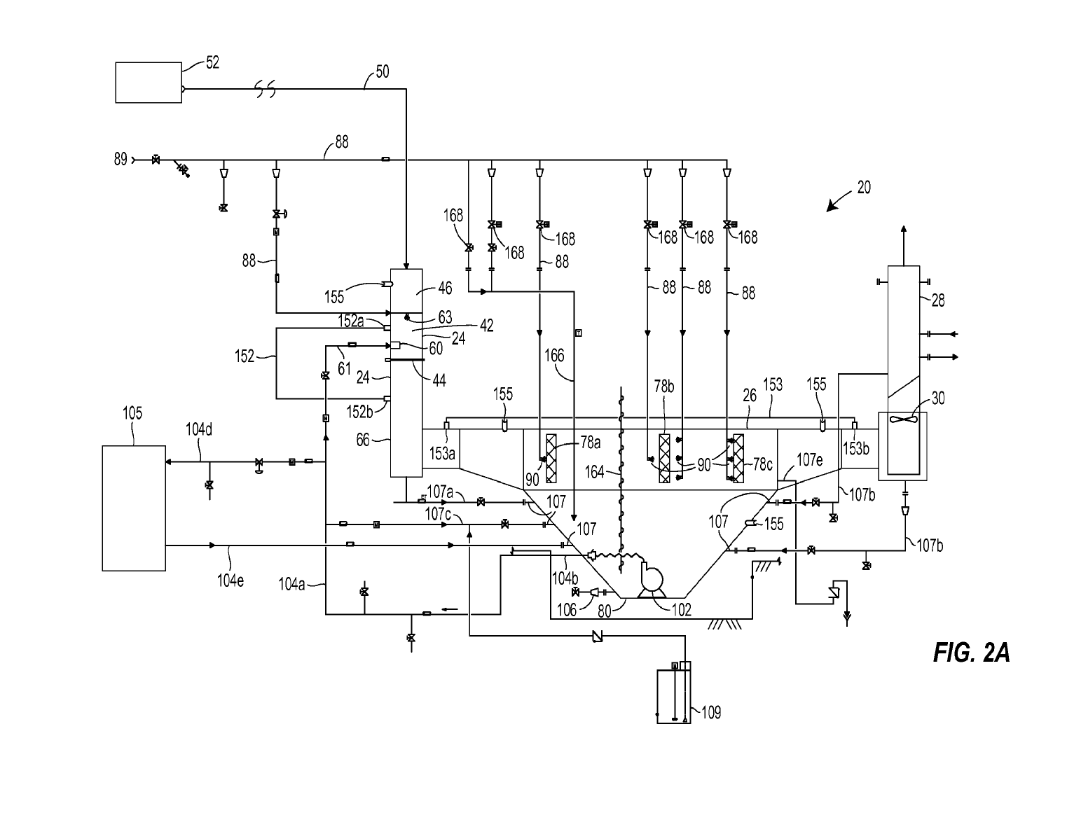

The liquid evaporator assembly 24 is arranged to receive wastewater and evaporate water from the wastewater into a stream of gas, such as hot waste gas from the exhaust of another process. The liquid evaporator assembly 24 preferably includes a venturi evaporator, which evaporates the water by mixing the wastewater and gases and passing the mixture through a venturi section that rapidly reduces the static pressure of the mixture and further mixes the wastewater and gases an amount sufficient to cause rapid evaporation of the water from the wastewater. As best seen in FIG. 2, the liquid evaporator assembly 24 includes a mixing chamber 42 connected with a venturi assembly 44, which together define a first portion P1 of the confined gas flow path P.

The mixing chamber 42 has a gas inlet 46 arranged for connection with one or more sources of gases, and two opposing slanted side walls 48a, 48b that at least partly define and narrow the first portion P1 of the confined gas flow path from the gas inlet 46 toward the venturi assembly 44. Thus, the confined gas flow path P has a first cross-sectional area on an inlet, or upstream side of the slanted walls 48a, 48b and a second, smaller cross-sectional area on a venturi, or downstream side of the slanted walls. The mixing chamber 42 is preferably elevated above the venturi assembly 44 and may be adapted to be coupled with a supply manifold 50 (not shown) that collects heated gas from one or more separate sources of heated exhaust gases. In the arrangement depicted in the drawings, the gas inlet 46 has a cylindrical tube section 46a, a transition section 46b that transitions from a circular cross-section to a rectangular cross-section that exhausts into an elongate rectangular tapered trough section defined partly by the slanted side walls 48a, 48b that extend between two side walls.

A plurality of injection nozzles 60 project into the trough section of the mixing chamber 42 downstream of the gas inlet 46 and upstream of the venturi section 44. Each injection nozzle 60 is connected with a supply of wastewater, such as concentrated wastewater from wastewater return pipes 61 disposed on opposite exterior sides of the trough section, and is arranged to inject the wastewater into the mixing chamber 42 directly against one of the slanted side walls 48a, 48b. The wastewater return pipes 61 in a preferred arrangement carry re-circulated concentrated wastewater, such as concentrated wastewater drawn from the gas-liquid separator 26. Each injection nozzle 60 includes a nozzle section that is pointed downwardly toward, and adapted to inject the wastewater against, the adjacent slanted side wall 48a or 48b. Injecting the wastewater against the slanted side walls 48a, 48b precludes (or reduces) the development of fine droplets prior to entry of the gas/liquid mixture into the venturi assembly 44. This, in turn, prevents complete drying of fine droplets (which could cause fouling problems) because once the fine droplets are formed in the venturi assembly 44, complete drying is minimized or eliminated due to the limited residence time and the fast approach to adiabatic saturation temperatures. Moreover, any dry particulate that may be formed is scrubbed off of the side walls due to the high velocities in the venturi assembly 44. Preferably, the nozzle section is connected to the wastewater return pipe 61 by a liquid supply conduit, which in some instances extends horizontally from the wastewater return pipe 61. In some arrangements, either the nozzle section extends downwardly through a horizontal wall of the mixing chamber or the liquid supply conduit extends horizontally through a sidewall of the mixing chamber 42. In other arrangements, the lowest distal end of the nozzle section may be flush with the horizontal wall of the mixing chamber. The nozzle section may be formed of an open ended tube, and the liquid supply conduit may be formed of another tube that has an inside diameter less than an inside diameter of the open ended tube. In a preferred arrangement, the liquid evaporator assembly 24 includes four of the injection nozzles 60, two directed against each of the opposing slanted side walls 48a, 48b, and each nozzle section has an inside diameter of between approximately 10 mm and 0.5 mm and preferably approximately 2.5 mm (1 inch). However, fewer or more injection nozzles may used. Optionally, the nozzles 60 and/or the nozzle sections are removably secured to provide for easy removal, maintenance, and re-installation.

Nozzle shrouds 65 optionally are arranged to protect the nozzles 60 from direct contact with the heated gases from gas inlet 46. Because the heated gases may have very hot temperatures, such as of several hundreds of degrees Celsius, direct contact with the nozzles may cause excessive scaling of salts on the nozzles 60 and thereby lead to plugging and/or otherwise cause decreased functionality. Preferably, the nozzle shrouds 65 are disposed between each nozzle 60 and the direct stream of heated gases and arranged to deflect the direct stream of heated gasses from impinging against the nozzles 60. For example, the shrouds 65 depend or extend downwardly from the horizontal wall of the mixing chamber between the nozzle section and the opening between the gas inlet 46 and the mixing chamber 42. Preferably, each shroud 65 extends downwardly past the lowest distal end of the nozzle section.

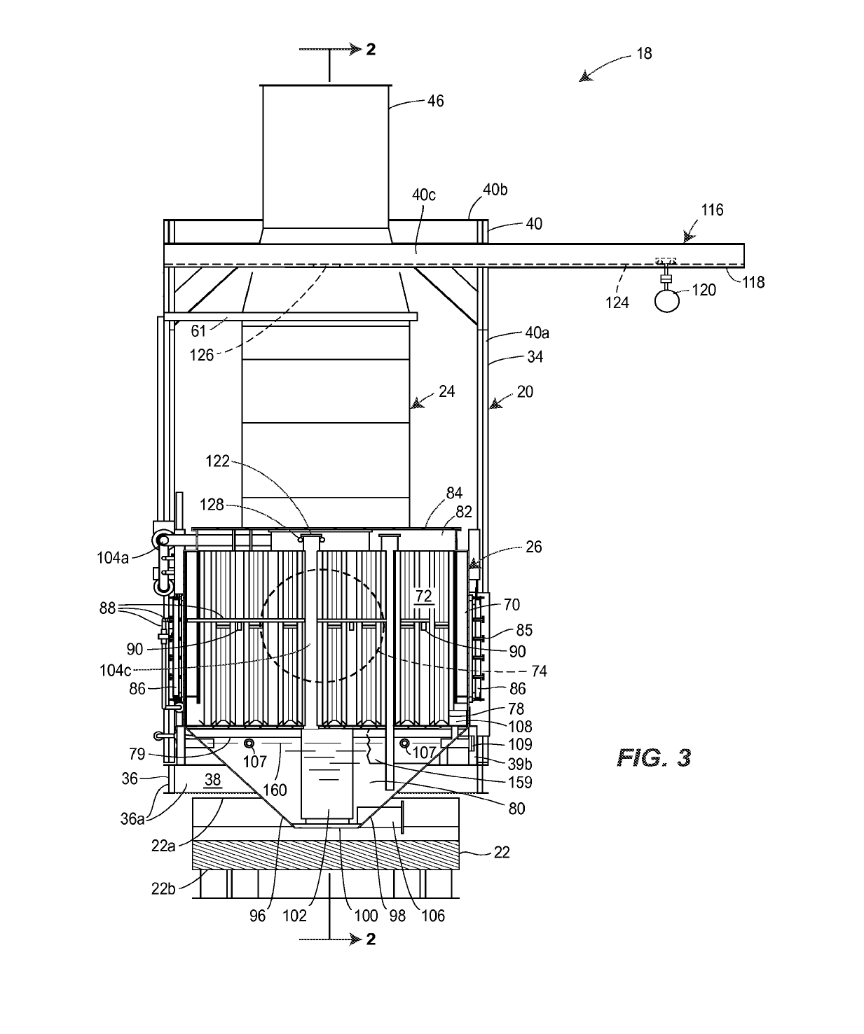

In a preferred option, raw or un-concentrated wastewater, i.e., wastewater that has not been treated by the portable wastewater concentrator 20, is supplied to the confined gas flow path P at a location upstream from the nozzles 60. In one arrangement, the raw wastewater is injected into the confined gas flow path P with one or more feed nozzles 63 (FIG. 3). The feed nozzles 63 are located to inject the raw wastewater into the gas inlet 46 or into the manifold. The raw wastewater injected with the feed nozzles 63 in some instances may quench the hot gasses from the heat sources 52. Quenching includes cooling the hot gasses and entraining the raw wastewater into the flow of hot gasses prior to reaching nozzles 60 and/or entering the mixing chamber 42. In some arrangements, the feed nozzles 63 are arranged to inject the raw wastewater as droplets to increase quenching.

The venturi assembly 44 receives the mixture of gas and wastewater from the mixing chamber 42 and includes an adjustable throat 58 arranged to allow selective variation of the cross-sectional area of the venturi to increase or decrease the velocity of the gases and thus the pressure drop across the throat. The cross-sectional area of the adjustable throat 58 may be increased or decreased in any available manner, such as with one or more movable orifice plates 68. In one arrangement, the orifice plate 68 is formed by a baffle that is pivotable around a hinge between a first position that closes the throat 58 and a second position that opens the throat 58. The orifice plate 68 may be pivoted by any actuator (not shown) sufficient to controllably move the baffle between the first and second positions, such as a gear and/or lever arm functionally connected with a linear actuator, a rotary actuator, a manual positioning actuator, and/or a servo motor. In the depicted arrangement, the throat 58 is formed of a narrow rectangular duct section attached to the narrowest portion of the trough section of the mixing chamber and an outwardly tapered rectangular duct section extending from a downstream side of the narrow rectangular duct section. The orifice plate 68 is a rectangular plate that pivots around an axis, such as a rod or hinge, extending along one side of the long dimension of the narrow rectangular duct section forming the throat 58. Although only one orifice plate 68 is shown in the drawings, larger units, such as units designed to process 40,000 gallons or more per day, may include two movable orifice plates 68 across the throat 58, for example disposed on opposite sides of the throat 58 and arranged to close by moving toward each other and to open by moving away from each other.

The mixing chamber 42 and the venturi assembly 44 are preferably oriented generally vertically, as shown in the drawings, with the mixing chamber disposed above the venturi assembly, which in some arrangements provides for even distribution of wastewater across the cross-sectional area of the first portion P1 of the confined flow path P. The liquid evaporator assembly 24 as shown also includes an elbow duct section 66 connected to the downstream side of the outwardly tapered rectangular duct section of the venturi assembly 44 and connected to the gas-liquid separator 26. The elbow duct section 66 is arranged to conduct the mixture of gases and wastewater from the venturi assembly 44 into the gas-liquid separator 24. The elbow duct section 66 rests on and is supported by the top the support frame 39a. In the depicted arrangement, the mixing chamber 42, the venturi assembly 44, and the elbow duct section 66 have generally rectangular cross-sectional forms. However, the mixing chamber 42, the venturi assembly 44, and the elbow duct section 66 may have other shapes and arrangements.

A flooded elbow is formed at the bottom of the elbow duct section 66 by a sump 67 located where the duct changes direction from a vertical air flow path to a horizontal air flow path. The sump 67 is formed by a shallow recess at the bottom of the vertical section of the elbow duct section 66 and includes a raised lip 69 or weir between the sump 67 and an inlet 74 into the gas-liquid separator 26. As mixed wastewater and gasses flow from the venturi 44, the abrupt change in direction of the mixture from the vertical to the horizontal, such as approximately a 90 degree angle, causes at least some heavier droplets of wastewater to collect in the sump 67. As wastewater collects in the sump 67, the level of the collected wastewater rises until the collected wastewater overflows the raised lip 69 and runs down the inlet 74 into the sump 80 of the gas-liquid separator. Thus, the sump 67 forms a preliminary or first stage water removal. The collection of wastewater in the sump 67 may also reduce erosion of the interior surface of the elbow duct section 66 that may otherwise be caused by entrained suspended solids, such as precipitated particles, within the high velocity flow of gasses and wastewater.

The gas-liquid separator 26 includes a body 70 defining an enclosed separation chamber, such as a demister chamber 72, the inlet 74 that receives the mixture of gases and wastewater from the venturi assembly, an exhaust outlet 76 that is connected with the exhaust assembly 28, and a sump 80 disposed at a bottom of the body. The gas-liquid separator 26 defines a second portion P2 of the confined gas flow path P, which extends through the demister chamber 72 from the inlet 74 to the exhaust outlet 76. The body 70 has a generally rectangular polyhedron shape surrounding the demister chamber 72, having a rectangular top panel, and opposing rectangular side walls extending down from opposite side edges of the top panel. Each of the inlet 74 and the exhaust outlet 76 has a truncated pyramidic shape, having top, bottom, and opposite side walls, each of which tapers or slopes outwardly from the respective inlet and outlet toward the demister chamber 72. When assembled in a preferred operating position, the inlet 74 and the exhaust outlet are aligned substantially horizontally along a longitudinal axis X through the body 70.

One or more, and preferably three demister panels 78a, 78b, and 78c are disposed inside the demister chamber 72 and arranged to separate wastewater entrained in the gases from the gases. Preferably, the demister panels 78a-c are disposed across the confined gas flow path P with each forming a tortuous gas flow path through demister chamber 72 to separate entrained wastewater droplets from the gases. In the depicted embodiment, for example, the second portion P2 of the confined gas flow path P extends along the substantially horizontal longitudinal axis X from the inlet 74 to the exhaust outlet 76, and the demister panels 78 are aligned generally orthogonally to and across the longitudinal axis. The demister panels 78b, 78c closest to the exhaust outlet 76 are preferably chevron demisters and are aligned vertically and orthogonally across the second portion P2 of the confined gas flow path. The chevron demisters are carried by a generally rectangular peripheral support frame that extends around a peripheral side edge of each chevron demister. The demister panel 78a closest to the inlet 74 is preferably formed of half-tube sections, similar to common sheet-piling sections, that are vertically oriented and horizontally spaced apart and overlapping, carried by a support frame. The half-tube sections are slanted or sloped between approximately two degrees and fifteen degrees from the vertical. The support frame includes vertical side posts on opposite ends of the half-tube sections, and a support member, such as a horizontal rod that extends between the vertical side posts. Preferably, each demister panel 78a-c has a generally planar peripheral form factor and spans the entire area across the demister chamber 72 between the side walls and top wall of body 70 to force the gases and entrained wastewater to go through each demister panel to ensure maximum separation of entrained wastewater from the gases. Each of the demister panels 78a-c preferably is assembled to be moved as a single unit, with each demister panel carried by the support frame for easy installation into and removal from the demister chamber 72, for example as describe hereinafter.

A screen 79, such as an elongate metal grate, is disposed inside the gas-liquid separator 26 immediately below the bottom of the demister panel 78a. The screen 79 is arranged to prevent large particles knocked down by the demister panel 78a, such as trash or cinders, from falling into the sump 80 and subsequently being sucked through the sump pump 102. The screen 79 extends completely from the left to right side walls of the body 70 and is supported from the sump by, for example, a brace 79a.

A top access opening 82 is formed in the top wall of the body 70 directly above each demister panel 78a-c to allow each demister panel to be installed and removed vertically through the top wall, by a hoist or crane, for example. Each top access opening 82 preferably is covered with a removable hatch 84, such as a door or panel, bolted or otherwise latched to the body, or preferably, retained in a closed position by a quick-release latching system 85 that can be quickly locked and unlocked, such as pivotable latches and cam locks, and/or spring latches, without requiring disassembly of the locking mechanism. Each top access opening 82 is shaped complementary to the respective demister panel 78, such as by being, for example, in the shape of a long narrow rectangular slot having a width slightly larger than a width of the respective demister panel 78 and a length slightly longer than a length of the respective demister panel. Thus, for example, the top access openings 82 shown in the drawings extend completely to each opposite side wall of the body 70.

A plurality of access doors 86 are disposed in side walls of the body 70, the inlet 72, and the exhaust outlet 74 to provide ready access to all regions of the interior of the gas-liquid separator 26. The access doors 86 are releasably retained in a closed position by the quick-release latching system 85 that can be quickly locked and unlocked, such as pivotable latches and cam locks, and/or spring latches, without requiring disassembly of the locking mechanism. The access doors 86 are preferably sized to allow easy ingress and egress of a person into and out of the gas-liquid separator 26.

A wash water system is included as part of the gas-liquid separator 26 to easily wash scale and/or other accumulated solids off of the demister panels 78. In one exemplary arrangement, as best seen in FIG. 2A, feed pipes 88 extend into the demister chamber 72 and feed wash water to a number of nozzles 90 that are arranged to spray the wash water onto the demister panels 78. The feed pipes 88 are connected with a source 89 of wash water (not shown), preferably the raw wastewater, and one or more pumps (not shown) may be connected with the feed pipes to pump the wash water to the nozzles 90 to spray the demister panels 78. Optionally, at least one of the feed pipes 88 in one arrangement also is arranged to provide wash water to the mixing chamber 42 to wash the internal area of the mixing chamber and/or to supply the feed nozzles 63.

The sump 80 defines the bottom of the gas-liquid separator 26, and preferably is defined by a bottom of the body 70 directly below the demister chamber 72. The sump 80 is arranged to collect wastewater that has collected in the sump 67 of the elbow duct section 66, on the inner walls of the demister chamber 72, and on the demister panels 78, such as by being disposed directly below the demister panels 78 so that wastewater collected on the demister panels 78, the sump 67, and the inner walls of the demister chamber 72 can drip downwardly under the force of gravity and be collected in the sump. The sump 80 projects downwardly from the body 70 through the central opening 38 of the horizontal support frame 36 and below the skid 34 and may be scaled up or down as needed to accommodate treatment capacities of more than approximately twenty thousand gallons per day, and preferably between at least twenty thousand and sixty thousand gallons per day, and in one preferred embodiment up to at least approximately forty thousand gallons per day and more. The sump 80 is shaped and arranged to collect wastewater from the sump 67 and all regions of the demister chamber 72 and preferably has slanted or sloped walls extending downwardly from around the entire outer periphery of the demister chamber, such as having the form of an inverted cone or a truncated inverted pyramid with four sloped walls, a front wall 92 closest to the inlet 74, a rear wall 94 closest to the exhaust outlet 76, and two side walls 96, 98 spanning from the front wall to the rear wall, extending downwardly from the bottom of the body 70 directly below the demister panels 78. The truncated inverted pyramid form also preferably includes a bottom wall 100 connecting the bottom ends of the sloped side walls 92, 94, 96, 98. At least one, and preferably each, sloped wall 92, 94, 96, 98 forms an angle between 0 degrees and 90 degrees from the horizontal longitudinal axis X of the gas-liquid separator 76. For example, the front wall 92 is sloped at an angle of between approximately thirty five degrees and sixty five degrees from the horizontal longitudinal axis X, and more preferably an angle of approximately fifty five degrees. Each of the rear wall 94 and two side walls 96, 98 is preferably sloped at an angle between approximately forty five degrees and approximately fifty five degrees, and more preferably at an angle of about forty five degrees from the horizontal longitudinal axis X. The bottom wall 100 of the sump 80 preferably defines a lowest hydraulic point in confined gas flow path P through the wastewater concentrator 20, and a submersible sump pump 102 is disposed on the bottom wall 100 at the bottom of the sump 80. The submersible sump pump 102 pumps wastewater that collects in the sump 80 through a recirculation system that returns the collected wastewater to the injection nozzles 60 for recirculation through the liquid evaporator assembly 24. In a preferable mode of continuous operation, a slipstream of the submersible pump 102 discharge may be withdrawn from the concentrator 18 system at a controlled rate to maintain a desired equilibrium level with regard to a degree of concentration of the feed wastewater.

In one arrangement, the sump 80 is secured to the demister chamber 72 such that the sump 80 may be removed, such as for transportation, and/or attached at the operating site, such as when the wastewater concentrator 20 is set up for operation at an operating site. The sump 80 may be releasably attached in any manner sufficient to allow selective attachment and removal. Some exemplary releasable attachment mechanisms include releasable fasteners, such as bolts or clamps, or with releasable interlocking mechanisms, such as bayonet-type locking mechanisms, or other similar releasable interlocking mechanisms. In one arrangement, the sump 80 is attached to the demister chamber 72 at the operation site with fiberglass. In another arrangement, the sump 80 is removably secured to the demister chamber 72 with a flexible joint, such as a rubber boot. Removably securing the sump 80 to the demister chamber 72 may be particularly useful for larger capacity units, such as a wastewater concentrator sized to process 100,000 gallons of wastewater per day or more. Thus, the releasable attachment mechanisms may make scaling the size of the wastewater concentrator 20 easier and more adaptable.

Turning again to FIG. 2A, the recirculation system includes a recirculation pipe system 104 that returns collected wastewater back to the nozzles 60 via the wastewater return pipes 61, and the sump pump 102 to pump the wastewater through the recirculation pipe system 104. The recirculation pipe system 104 includes a main return pipe 104a, which connects to a pipe 104b extending into the sump 80 through the side wall 96 and to a pump lifter pipe 104c or a hose connected to the sump pump 102. The main return pipe 104a connects to the wastewater return pipes 61 to feed the concentrated wastewater back to the nozzles 60.

A secondary return pipe 104d branches off from the main return pipe 104a and connects with a slurry thickening and storage system 105 for the concentrated wastewater. In one arrangement, the slurry thickening and storage system 105 may be arranged to thicken the concentrated wastewater and to store the thickened slurry before further processing in a batch treatment plant, as will be discussed further below. Thickened slurry is the result of settling suspended solids which are primarily the result of forced precipitation within the concentrator system 118. The slurry thickening and storage system 105 may include one or more storage and/or mixing tanks in which thickeners and/or coagulants may be added to the concentrated wastewater to further hasten settling of suspended solids as thickened wastewater, and/or one or more settling or stirring tanks in which sediments are allowed additional time to settle out of and be separated from the concentrated wastewater. Preferably, supernatant liquids from settling operations are returned to the portable wastewater concentrator 20 where additional dissolved solids can be precipitated through concentration and therefrom be returned to the settling operations.

At least one drain port 106 is preferably disposed at the bottom of the sump, such as through the side wall 98 and/or through the bottom wall 100, in order to facilitate removal of accumulated sludge or slurry from the sump. The drain port 106 may be a flanged outlet pipe stub as shown in the drawings arranged for connection to removal piping or any other removal system. The drain port 106 may be connected by appropriate pipes and pumps with other ancillary processors, for further separation of solids from liquids. In some arrangements, the drain port 106 includes a valve to allow selective removal of sludge or slurry, and the drain port is arranged for connection with a removal vehicle, such as a vacuum truck or waste holding tank.

A plurality of stub pipes 107 extend into the sump 80 through the sloped side walls 92, 94, 96, 98 for intake and/or discharge of raw or concentrated wastewater or other liquid between the sump 80 and other processors. In one arrangement, at least one stub pipe 107 is connected with a collection pipe 107a that draws liquid condensate from the bottom of the elbow 66; at least one and preferably two stub pipes 107 are connected with collection pipes 107b that connect to respective upper and lower drains from the exhaust assembly 28; a stub pipe 107 is connected with a return pipe 104e from the slurry thickening and storage system 105; and a stub pipe 107 is connected with a return bypass line 107c from the main return pipe 104a. Optionally, anti-foaming agents may be added to the concentrated wastewater, for example through a line 107d connected with the return bypass line 107c from a mixer 109.

An overflow drain 107e is located through the body to maintain the top level 160 of wastewater at or below the desired height. Preferably, the overflow drain 107e is located at a level arranged to form a liquid seal along a baffle or skirt below the bottom of at least one, and preferably all of the demister panels 78a-c to be formed and/or maintained during operation.

A float or skimmer tray 108, such as a shallow pan or tray, is disposed on the one side wall of the body 70 at a level expected to be a top water line as defined by the sump pump 102 or other means. The skimmer tray 108 drains to an overflow pipe 109, which in some arrangements is connected with the recirculation pipe system 104 to return any overflow for reprocessing through the portable wastewater concentrator 20.

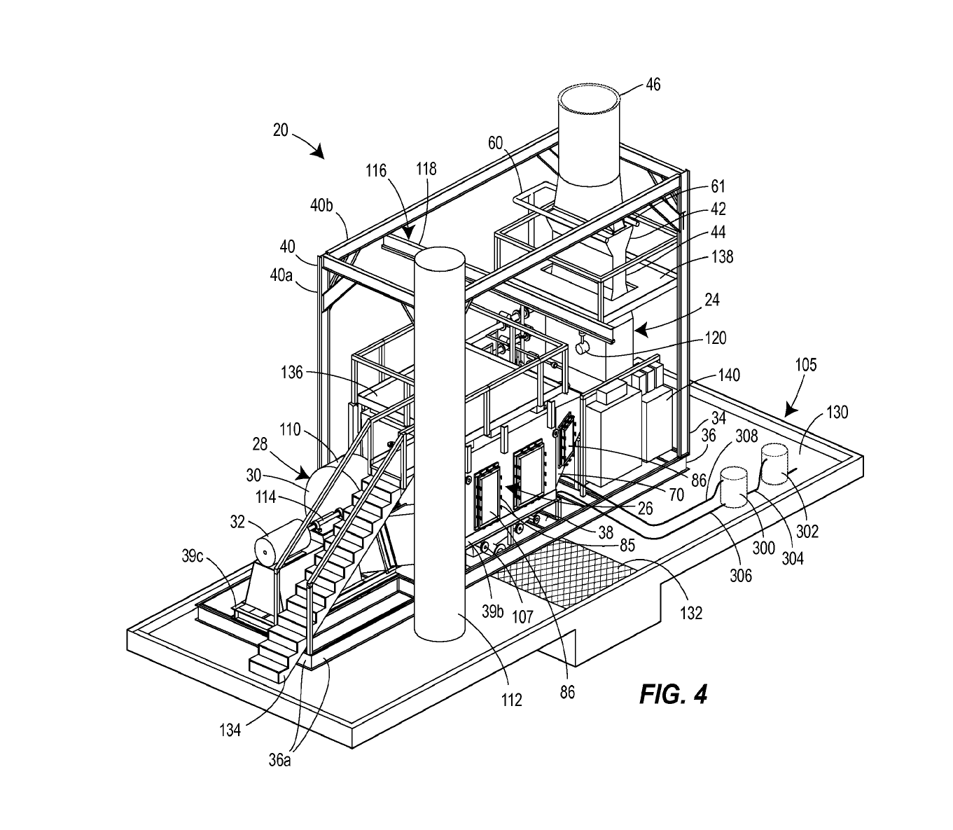

The exhaust assembly 28 in a preferred arrangement includes the air pump 30 and the power source 32. The air pump 30 is operatively connected with the confined gas flow path P to draw the gases through the liquid evaporator assembly 24 and the gas-liquid separator 26 and out the exhaust assembly 28 to the surrounding atmosphere. The air pump 30 may be operatively arranged in any location sufficient to effectuate movement of gases along the confined gas flow path P as described. In a preferred arrangement shown in the drawings, the air pump 30 includes a centrifugal fan with a shroud 110 that surrounds fan blades 111 and has an inlet that connects with the exhaust outlet 76 of the gas-liquid separator 26 and an outlet that connects with an optional exhaust stack 112 (shown in FIG. 4). The shroud 110 defines a third portion P3 of the confined gas flow path P from the inlet to the outlet. The power source 32 may be any power source sufficient to rotate a drive shaft that is attached to the air pump 30 and arranged to drive the fan blades, such as a gas or diesel internal combustion engine, a steam engine, an electric motor, a servo motor, a water paddle wheel, etc. Preferably, the power source 32 is arranged to drive the fan blades 111 at selected different speeds in order to be able to control the velocity and/or flow volume of gases along the confined gas flow path P at least as described herein below. In the depicted arrangement, the power source 32 is located adjacent to the fan 30 opposite the gas-liquid separator 26 and drives a shaft 114 that is arranged to rotate the fan blades 111. The exhaust assembly 28 may further include additional ducts (not shown) to partly define the third portion P3 of the confined gas flow path P from the gas-liquid separator 26 to the exhaust stack 112 as desired for particular special arrangements and other design criteria peculiar to a particular application.

The exhaust stack 112 may take any form sufficient to direct exhaust from the outlet of the shroud 110 to the atmosphere, such as a vertical cylindrical shape shown in the drawings, and is separable from the shroud 110 and the remaining portions of the exhaust assembly 28. In a preferred arrangement, the exhaust stack 112 is not carried by the skid 34, but rather is carried separately from the portable wastewater concentrator 20 and attached to the outlet of the shroud 110 at the operation site by any convenient means, such as with bolts or by welding. The exhaust stack 112 may be supported by a support surface separate from the skid 34.

A crane 116 is supported by the lift frame 40 above the top access openings 82 and arranged to install and remove the demister panels 78 through the upper portals top access openings 82. The crane 116 in one arrangement is in the form of an overhead or gantry crane and includes a support beam 118, such as an I-beam, C-section beam, or box beam, supported by opposite cross-beams 40b over the upper portals and carrying a lift 120, such as a pulley, a cable hoist, or other lifting mechanism. The support beam 118 may be movable along the cross-beams 40b, by being supported on trolleys or other moveable support system for example, to allow the support beam 118 to travel along the cross-beams 40b from the inlet 74 of the gas-liquid separator 26 to the exhaust outlet 76. The lift 120 may be supported by the support beam 118 and may also be movable along the cross-beams 40b by another movable support system, such as trolleys (not shown). Thereby, the lift 120 preferably is movable along two crossing axes defined by the cross-beams 40b and the support beam 118 to be positioned over all areas of at least the gas-liquid separator 26 and more preferably also over at least portions of the liquid evaporator assembly 24. In the depicted arrangement, the support beam 118 is oriented substantially perpendicular to the second portion P2 of the confined gas flow path P and moves along the cross-beams 40b substantially parallel with the second portion of the confined gas flow path. Optionally, each demister panel 78 includes a projection 122, such as a T-member or hook, arranged to be inserted into a track 124 defined along the support beam 118 and the projection 122 slides along the track 124 when the demister panel 78 is removed from the respective top access opening 82. The track 124 is preferably aligned transverse to the second portion P2 of the confined gas flow path P. The track 124 includes an open end 126 arranged to receive and release the projection 122 near, such as directly above, the top access opening 82, and the projection 122 preferably includes a roller 128, such as one or more caster wheels, that are received within the track 124 and facilitate moving the demister panel 78 transversely along the track. In another arrangement, the crane 116 is in the form of a jib crane (not shown). In this arrangement, the support beam 118 forms a boom that is arranged to rotate horizontally over the top of at least the gas-liquid separator 26. The support beam 118 of the jib crane may be supported directly from one of the beams 40b of the lift frame 40 or may be supported by a vertical support, such as one of the columns 40a or a separate column (not shown), and arranged to rotate about the vertical support.

Referring now particularly to FIG. 4, the wastewater concentrator 20 is illustrated operatively assembled at an operation site and located on a support surface, such as a concrete pad 130 on the ground, that includes a recess, such as a trough 132, arranged to receive the portion of the sump 80 that projects below the skid 34. Appropriate covering, such as grating, may cover portions the trough 132. The skid 34 rests directly on and is supported by the concrete pad 130 and preferably maintains the remaining components of the wastewater concentrator 20 elevated above the top surface of the concrete pad 130. The exhaust stack 112 rests on the concrete pad 130 directly adjacent to the skid 34. Additional accessory structures, such as an access stair 134 and access platforms 136 and 138 also may be attached to the wastewater concentrator 20 at the operation site in any convenient manner, such as welding or bolting. The access stair 134 is arranged to allow an operator to climb from the concrete pad 130 to the access platform 136, which preferably is located over the top of the gas-liquid separator 26 and below the crane 116, to provide ready access to the top access openings 82 and the removable hatches 84. The access platform 138 is arranged to provide access to the liquid evaporator assembly 24, such as by providing a walking platform surrounding the venturi assembly 44 at a height sufficient to provide easy access to the injection nozzles 60. Other access structures may be included, such as additional walk ways, ladders, and platforms. Structures such as the access stairs 134, access platforms 136 and 138, the exhaust stack 112, and the header connection assembly 50 are preferably attached to the wastewater concentrator 20 at the operation site after the skid 34 has been placed in the intended operating location, such as on the concrete pad 130. These structures are preferably pre-formed to be easily attached by any method that requires a minimum of construction effort on site, such as with bolts, clips, and/or welding.

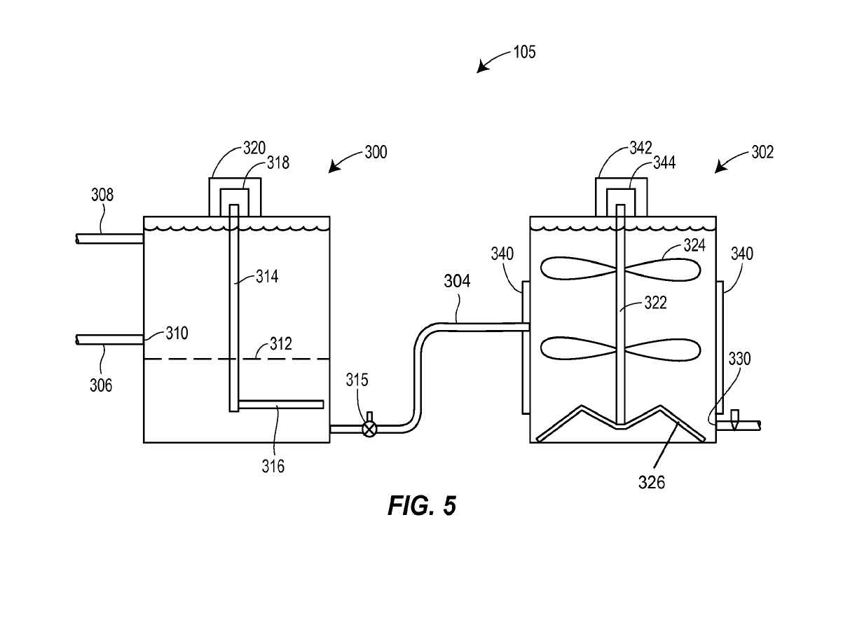

The slurry thickening and storage system 105 may be located on the concrete pad 130 proximate the wastewater concentrator 20. In other embodiments, the slurry thickening and storage system 105 may be located on the skid 34 and transported with the wastewater concentrator 20 as a single unit. The slurry thickening and storage system 105 includes a slurry thickening tank 300 and a thickened slurry storage tank 302 that are fluidly connected to one another by a connecting pipe 304. The slurry thickening tank 300 is fluidly connected to the sump 80 by an inlet pipe 306, which directs concentrated liquid or slurry from the sump 80 to the slurry thickening tank 300. The slurry is further separated and concentrated in the slurry thickening tank 300 where suspended solids settle toward the bottom leaving supernatant liquid toward the top of the thickening tank 300, the supernatant liquid containing substantially reduced amounts of suspended solids. A portion of the liquid constituent may be drawn off and fed back to the sump 80 through return line 306 for further evaporation/concentration. A thickened portion of the slurry may be fed to the storage tank 302 through the connecting line 304 for storage and/or further disposal. The slurry thickening and storage system 105 will be discussed in more detail below with respect to FIG. 5.

A control panel 140 is preferably included as part of the wastewater concentrator 20, such as by being secured to the skid 34, with power supply and control wiring for various components that require electrical power or other electrical wiring, such as the air pump 30, sump pump 102, movable orifice plate 68, crane 116, and control systems. The control panel 140 preferably also includes any hydraulic controls and/or other controls for other various portions of the portable wastewater concentrator 20. The control panel 140 is preferably pre-connected to the various components so that the no significant wiring or connects need to be made after the wastewater concentrator 20 arrives at an operation site. The control panel 140 in some arrangements includes a main power hook-up for connection to electrical power supplied at the operation site. In other arrangements, the control panel 140 is adapted to receive electrical and/or hydraulic power from generators and/or hydraulic pumps, respectively, powered by the power source 32 and attached as part of the wastewater concentrator 20.

Turning now to FIG. 5, the slurry thickening and storage system 105 is illustrated in more detail. As discussed above, the slurry thickening tank 300 is fluidly connected to the sump 80 of the wastewater concentrator 20 by an inlet pipe 306 and an outlet pipe 308. A pump may deliver concentrated liquid or slurry from the sump 80 to the slurry thickening tank 300 periodically or continually when a desired concentration of the concentrated liquid is reached. In one embodiment, the desired concentration may include between 50% and 70% total solids with between 20% and 40% suspended solids. The concentrated liquid enters the slurry thickening tank 300 through an inlet 310. Once inside the slurry thickening tank 300, suspended solids in the slurry settle towards the bottom of the thickening tank 300 forming a solids-liquid boundary 312. Below the solids-liquid boundary 312, suspended solids may make up more than 80% of the slurry while above the solids-liquid boundary 312, the supernatant liquid is substantially free of suspended solids.

Although the slurry below the solids-liquid boundary 312 is primarily made up of combined dissolved and suspended solids, a significant amount of liquid may still be present. A stirring rod 314 and rake 316 rotate within the slurry thickening tank 300 at a relatively slow rate, preferably between 1 RPM and 10 RPM, more preferably between 1.5 RPM and 5 RPM and even more preferably between 1.5 RPM and about 3 RPM. Stirring the slurry below the solids-liquid boundary 312 gently agitates the slurry, and more particularly agitates the suspended solid particles within the slurry, causing the suspended solid particles to settle further towards the bottom of the thickening tank 300 thereby ensuring that the supernatant liquid above the solids-liquid boundary 312 remains substantially free of suspended solids, thereby further concentrating the solids in the slurry below the solids-liquid boundary 312. Generally, the solids below the solids-liquid boundary 312 are further concentrated to more than 90% solids and less than 10% liquid.

Once a desired solids concentration is reached, slurry from below the solids-liquid boundary 312 is pumped or otherwise delivered to the thickened slurry storage tank 302 by a pump 315 through the connecting pipe 304. Because the slurry stored in the slurry storage tank 302 has a very high percentage of solids and a very low percentage of liquids, the slurry is prone to accretion of suspended solids, which is undesirable because accreted solids would be more difficult to remove from the slurry storage tank 302. To prevent accretion, a mixing shaft 322 spins slowly within the slurry storage tank 302. In one embodiment, the mixing shaft 322 spins between 30 RPM and 60 RPM, preferably between 40 RPM and 50 RPM, and more preferably between 42 RPM and 48 RPM. A plurality of stirring blades 324 is connected to the mixing shaft 322. The plurality of stirring blades 324 further agitates the slurry within the slurry storage tank 302 to prevent accretion of suspended matter. A breaker mechanism 326 may be attached to a bottom of the mixing shaft 322 to break up any accretion of suspended matter that may form on the bottom of the storage tank 302. Periodically slurry may be removed from the slurry storage tank 302 from a slurry outlet 330 for further treatment and/or disposal. The slurry outlet 330 may include a valve 332 for selectively opening and closing the slurry outlet 330.

In one preferred embodiment, the slurry thickening tank 300 may be approximately 16 feet tall, having a diameter of approximately 10 feet, with design specifications allowing storage of approximately 8,000 gallons at up to 1.6 specific gravity (13.34 lb/gal). The slurry thickening tank 300 may have an open top for operating at atmospheric pressures. The inside of the slurry thickening tank 300 may include a protective epoxy liner for protecting the slurry thickening tank 300 from corrosion or other damage from e.g., salt solutions and other damaging compounds. In one embodiment, the epoxy liner may be approximately 30 mil thick. An outside of the slurry storage tank 300 may include a dual layer protective coating having a first layer of approximately 6 mil thick epoxy and a second layer of approximately 2.5 mil thick acrylic polyurethane. An agitator gear box 318 may be connected to a motor, such as an electric motor 320, to drive the stirring rod 312. The electric motor in one embodiment may be a 2 HP 460 V, 3 phase, 60 HZ TEFC motor that delivers approximately 70,400 in-lb of maximum torque at approximately 2 RPM. The agitator gear box may include a heavy duty single reduction, single planetary gear, balance weight driven assembly.

In another preferred embodiment, the slurry storage tank 302 may be approximately 20 feet, 10 inches tall and approximately 30 feet in diameter, with design specifications allowing storage of approximately 20,600 gallons of liquid at up to approximately 1.9 specific gravity (15.85 lb/gal). The slurry thickening tank may be fabricated from a chemical resistant vinyl ester resin with a closed top. A 2 inch poly foam insulation layer with FRP overwrap and an exterior gel coat with UV inhibitor may be applied to the outside of the slurry storage tank 302 to protect the slurry storage tank 302 from environmental factors. In some embodiments, an electric tank heater 340 may also be attached to the outside of the slurry storage tank 302, or disposed within the slurry storage tank 302, to heat the slurry stored in the slurry storage tank 302. Heating the stored slurry may assist in the prevention of accretion of suspended matter within the slurry storage tank 302. The electric tank heater 340 may be thermostatically controlled and supplied with approximately 3 KW of power at 120 V. The mixing shaft 322 may be connected to an agitator motor 342 by a agitator gearbox 344. The agitator motor 342 may preferably include a heavy duty explosion proof 15 HP, 460 V, 3 phase, 60 HZ electric motor. The agitator gearbox 344 may include a parallel shaft, helical gear assembly that provides long bearing life and long service life. The plurality of stirring blades 324 may include one or more blades made of 316 stainless steel that are connected to a 2205 alloy mixing shaft 322 with a Hastelloy C-276 bolting. The plurality of stirring blades 324 promote a homogeneous mixture of suspended solids within the slurry stored in the slurry storage tank to prevent solidification of the slurry.

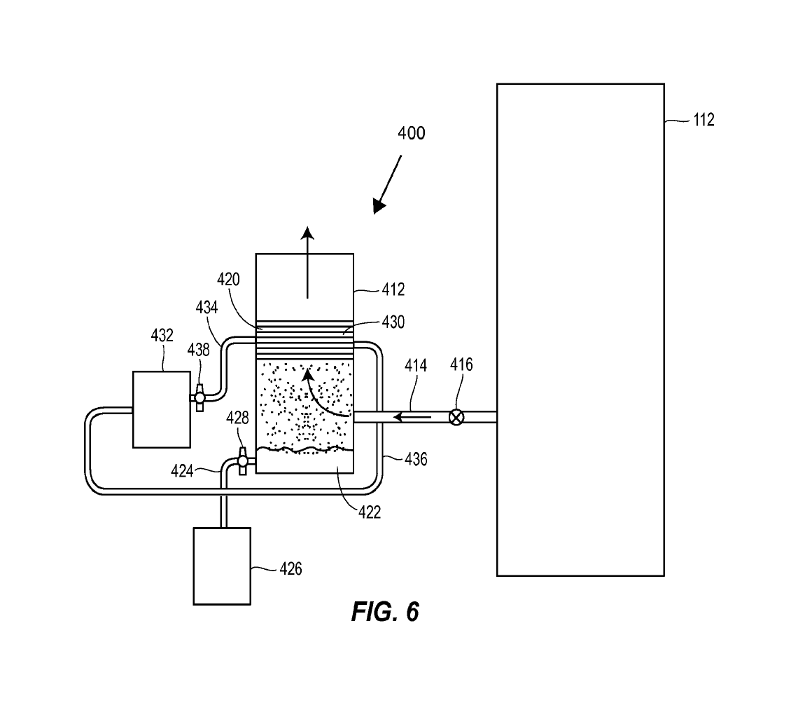

In some locations it may be desirable to recover a portion of the evaporated water vapor from the exhaust stack 112 of the wastewater concentrator 20. Recovered evaporated water vapor that is condensed back into liquid form may be used on site for applications that require liquid water. One such application is aqueous blends used for hydro-fracking natural gas wells. By recovering a portion of evaporated water vapor from produced water from natural gas wells, the amount of fresh water that needs to be transported to remote well sites may be reduced. One embodiment of a water recovery assembly 400 for recovering evaporated water vapor is illustrated in FIG. 6. The water recovery assembly 400 may include a secondary exhaust stack 412 that is fluidly connected to the concentrator exhaust stack 112 by a vapor line 414. A fan 416 may be operatively connected to the vapor line 412 to draw a portion of vapor flowing through exhaust stack 112 into the secondary exhaust stack 412. The fan 416 may be operatively connected to the control panel 140 so that an operator may selectively activate or deactivate the fan 416 and more generally the water recovery assembly 400 in general.

After being drawn into the secondary exhaust stack 412, the vapor passes over a direct contact extended surface area heat exchanger 420 that cools the vapor by direct contact with cooling water, causing the water vapor to condense into liquid water on the heat exchanger surfaces. The combined cooling water and condensed water then drips down and collects in a secondary sump 422 near the bottom of the secondary exhaust stack 412. Liquid water may be extracted from the sump 422 through a recovered water line 424 and delivered to a recovered water storage tank 426 for later use. A valve or pump 428 may control delivery of the recovered water to the recovered water tank 426.

The direct contact heat exchanger 420 may include a heat exchanger surface 430 that is cooled by a supply of cool water 432. Cooled water may be delivered from the supply of cool water 432 to the direct contact heat exchanger 420 through a supply line 434. After passing through the direct contact heat exchanger 420, the now warmer water may be delivered back to the supply of cool water 432 through return line 436. Water in the supply of cool water 432 may be actively cooled by a cooling mechanism, or passively cooled by exposure to a cooler atmosphere. A valve or pump 438 may control the supply of cooled water to the direct contact heat exchanger to maintain a desired temperature at the heat exchanger surface.

In one embodiment, the direct contact heat exchanger 420 may include a 24 in CPVC direct contact condenser column with a high efficiency packing arrangement and a high efficiency entrainment separator mounted in a discharge section of the condenser column. A chemically corrosion resistant polypropylene plastic blower and motor may be used for the fan 416. The water recovery assembly 400 may be designed, in one embodiment, to condense approximately 1% to 5%, preferably between 2% and 4%, and more preferably approximately 2% of the water vapor that is evaporated from the feed water that is concentrated in the wastewater concentrator 20.

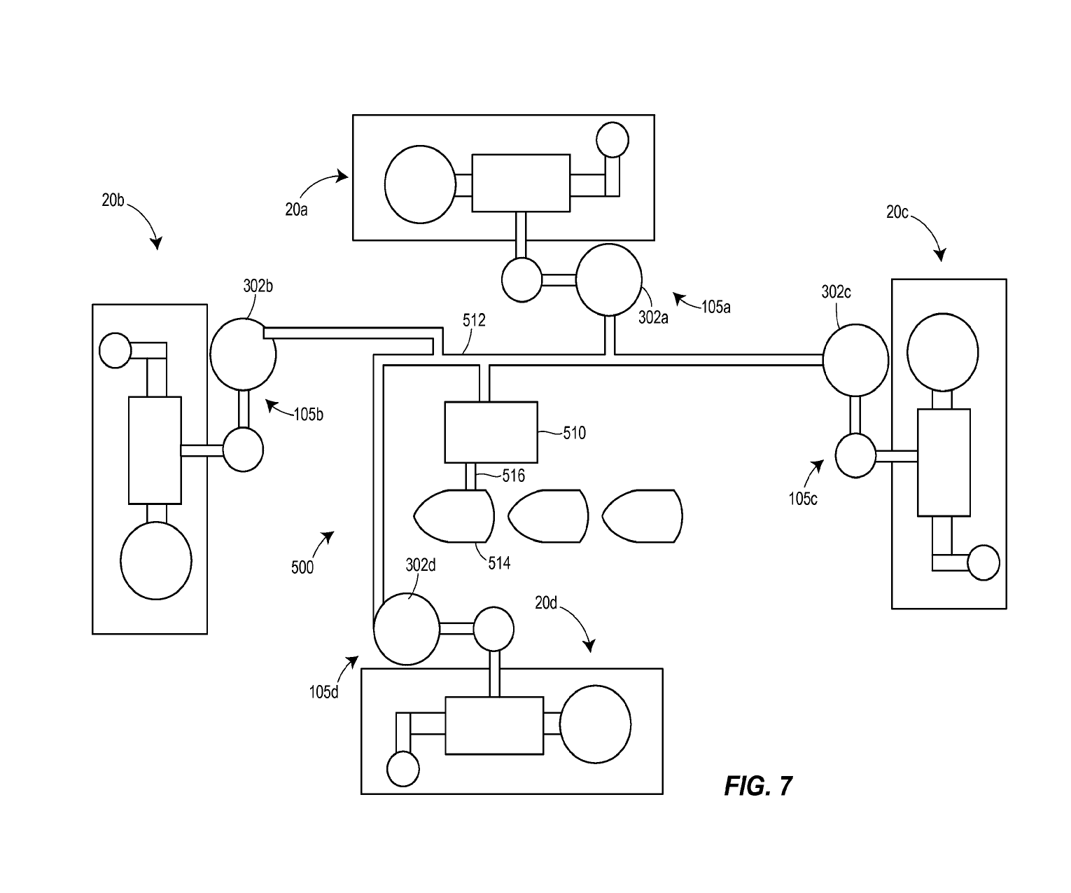

After slurry is thickened and stored in the slurry thickening and storage system 105, the slurry may be further treated and/or stabilized for ultimate disposal. The slurry thickening and storage systems 105 described herein advantageously allow slurry to be treated in a batch process, which is an efficient method of treating the thickened slurry. One embodiment of a slurry stabilization batch treatment plant is illustrated in FIG. 7. A plurality of concentrators 20a-20d may concentrate liquid from a plurality of sites, such as natural gas wells. Each concentrator 20a-20d may concentrate produced water from an individual natural gas well, or one or more of the concentrators 20a-20d may combine to concentrate produced water from a single natural gas well. Regardless, thickened slurry from one or more slurry storage tanks 302a-302d may be directed to a stabilization batch treatment plant 510. In one embodiment, the one or more of the slurry storage tanks 302a-302d may be fluidly connected to the stabilization batch treatment plant 510 by a manifold 512. In other embodiments, thickened slurry from the slurry storage tanks 302a-302d may be transported to the stabilization batch treatment plant 510 in a container that is moved by a vehicle, such as a tanker truck, or by any other transportation means, such as a conveyor belt.

The stabilization batch treatment plant 510 stabilizes and treats the thickened slurry so that the thickened slurry is transformed into an acceptable form for disposal in solid waste disposal sites, such as landfills. Thickened slurry enters the stabilization and batch treatment plant 510 through a thickened slurry inlet 511. Within the stabilization batch treatment plant 510, the thickened slurry is mixed with additives that remove or neutralize undesirable chemicals or compounds within the thickened slurry and with stabilizers that solidify the thickened slurry. In one embodiment, one additive may be gypsum, sodium sulfate, or other sulfate salts that bind barium within the thickened slurry so that the barium is transformed into an insoluble form that may be disposed of in a solid waste disposal site. In another embodiment, the thickened slurry may be mixed with Portland cement (or other stabilizing agent, such as, acidic or basic reagents, to adjust pH and hydrophilic gums, such as carboxymethyl cellulose and xanthan gum, to absorb and hold excess water that might exude from solidified mass that is treated with pozzalanic materials) to solidify the thickened slurry, rendering the thickened slurry acceptable for disposal in a solid waste disposal site.

Once the thickened slurry is treated and stabilized, the thickened slurry is delivered to a storage container 514 through a delivery channel 516. The storage container 514 may be configured to easily release the slurry once the slurry has solidified. In one example, the storage container 514 may take the form of a bin with an open top. The storage container 514 may be moved individually, or as a plurality, to a solid waste disposal site for disposal of the solidified slurry.

Treating and stabilizing the thickened slurry as described above prevents potentially harmful chemicals or compounds from leaching out of the slurry and into groundwater supplies at the solid waste disposal site. In particular, the methods of treating and stabilizing the slurry described above comply with local disposal regulations including the paint filter test. Moreover, the stabilization batch plant may be rapidly scaled to meet the needs of virtually any wastewater concentration operation. Further, such solidification at the site where the wastewater is generated might reduce transportation requirements for the wastewater by 75% or more.

The wastewater concentration system described herein may be useful for processing wastewater in many different applications. In some uses, the wastewater concentration systems can provide environmental benefits by re-capturing energy from exhaust heat gases from industrial processes to help separate clean water from wastewater and minimize environmental impact from transportation of wastewater to centralized treatment facilities.

Numerous modifications to the present wastewater concentration system and/or slurry thickening and storage system will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the present or any future claims are reserved. All patents, patent applications, and other printed publications identified in this foregoing are incorporated by reference in their entireties herein.

1-39. (canceled)

40. A batch treatment and stabilization plant for treating and stabilizing slurry formed from concentrating a wastewater stream, the batch treatment and stabilization plant comprising:
a central batch processing plant, the central batch processing plant including a slurry inlet, a slurry outlet, an additive, and a stabilizer.

41. The batch treatment and stabilization plant of claim 40, further comprising sulfate as one additive.

42. The batch treatment and stabilization plant of claim 40, further comprising Portland cement as one stabilizer.

43. The batch treatment and stabilization plant of claim 40, further comprising a plurality of slurry storage tanks that are operatively connected to the central batch processing plant.

44. The batch treatment and stabilization plant of claim 43, wherein each slurry storage tank in the plurality of storage tanks is fluidly connected to a wastewater concentrator.

45. The batch treatment and stabilization plant of claim 44, wherein at least one of the concentrators is operatively connected to a source of produced water from a natural gas well.

46. The batch treatment and stabilization plant of claim 40, further comprising a plurality of storage containers for storing slurry after being mixed with an additive or a stabilizer in the central batch plant.
